(19) United States
(12) Patent Application Publication
(10) Pub. No.: US 2020/0132924 A1
(43) Pub. Date: Apr. 30, 2020

(54) LIGHTING DEVICE AND DISPLAY DEVICE

(71) Applicant: SHARP KABUSHIKI KAISHA, Osaka (JP)

(72) Inventor: HIDEKI DAINOBU, Osaka (JP)

(21) Appl. No.: 16/661,560

(22) Filed: Oct. 23, 2019

(30) Foreign Application Priority Data
Oct. 30, 2018 (JP) 2018-203713

(51) Int. Cl. F21V 8/00

(52) U.S. Cl. CPC G02B 6/0088

(57) ABSTRACT

A lighting device includes a light exit member, a chassis including a bottom plate, a wall that extends from an outer peripheral portion of the bottom plate, a frame including a frame section opposite the bottom plate and covering an open edge of the open section, and a wall cover section extending from an outer peripheral edge of the frame section toward the bottom plate and coveting an outer periphery of the wall, and a reinforcing member disposed on a portion of an outer periphery of the frame and including a frame-side extending section extending along the outer periphery of the frame and overlapping the frame section, a chassis-side extending section disposed opposite the frame-side extending section, and the frame-side extending section and the chassis-side extending section holding the frame section and the bottom plate therebetween, and a connecting section connecting the frame-side extending section and the chassis-side extending section.

### CROSS REFERENCE TO RELATED APPLICATION

This application claims priority from Japanese Patent Application No. 2018-203713 filed on Oct. 30, 2018. The entire contents of the priority application are incorporated herein by reference.

### TECHNICAL FIELD

The technology described herein relates to a lighting device and a display device.

### BACKGROUND ART

A liquid crystal display panel is generally used as a display panel displaying an image or information in devices including electronic devices such as information terminals and meters mounted in a vehicle such as an automobile. Such a liquid crystal display panel does not emit light and therefore, such a type of liquid crystal display device includes a backlight unit (a lighting device) that supplies light to the liquid crystal display panel.

The backlight unit is generally classified into a direct type and an edge light type according to arrangement of a light source. The edge light type backlight unit is preferably used to reduce a thickness of the liquid crystal display device.

One example of such a liquid crystal display device includes a light source, a light guide plate, a reflection sheet, a metal chassis, and a resin frame. The light guide plate has a light entering surface that is opposite the light source and a light exit surface that faces a front side and through which the light exits. The reflection sheet is disposed to cover a plate surface of the light guide plate that is an opposite surface from the light exit surface. The light source, the light guide plate, and the reflection sheet are arranged in the metal chassis and the metal chassis includes a bottom plate that extends along the reflection sheet. The light guide plate is arranged between the resin frame and the metal chassis. Such a liquid crystal display device is described in Unexamined Japanese Patent Application Publication No. 2010-9787.

There have been demands of increase of size and decrease of thickness in display devices. According to such demands, the backlight unit is increased in size and decreased in thickness, and rigidity becomes poor and deformation such as warping or curving is likely to be caused in the backlight unit. As a result, luminance unevenness may be caused in the display device. If the backlight unit without having enough rigidity is included in a display device and such a display device is mounted in a vehicle and used under vibration, components of the backlight unit may be deformed due to the vibration and hit each other, and this may create noise.

### SUMMARY

To solve such a problem, the rigidity of the resin frame may be increased. However, the frame is formed to have relatively low rigidity to absorb distortion, a mounting tolerance, or twisting as a whole that is caused by the mounting tolerance. Therefore, increase of the rigidity of the frame may directly cause distortion of the backlight unit as a whole. Thus, there have been demands in the backlight unit to obtain both of flexibility of absorbing distortion or twisting and rigidity for keeping a shape thereof.

An object of the technology described herein is to provide a lighting device and a display device in which deformation such as warping or curving caused by increase of size and decrease of thickness of a display device is less likely to be caused and distortion or twisting is less likely to be caused and also noise is less likely to be caused even if the device is vibrated.

A lighting device according to the technology described herein includes a light exit member configured to exit light, a chassis including a bottom plate, a wall that extends from an outer peripheral portion of the bottom plate, and an open section opposite the bottom plate, the chassis in which the light exit member is arranged, a frame including a frame section and a wall cover section, the frame section being disposed opposite the bottom plate and covering an open edge of the open section, and the wall cover section extending from an outer peripheral edge of the frame section toward the bottom plate and covering an outer periphery of the wall, and a reinforcing member disposed on at least a portion of an outer periphery of the frame, the reinforcing member including a frame-side extending section extending along the outer periphery of the frame and overlapping the frame section, a chassis-side extending section disposed opposite the frame-side extending section, and the frame-side extending section and the chassis-side extending section holding the frame section and the bottom plate therebetween, and a connecting section disposed on an outer side of the wall cover section and connecting the frame-side extending section and the chassis-side extending section.

A display device according to another technology includes the above lighting device and a display device.

According to the lighting device and the display device of the present technology, deformation such as warping or curving caused by increase of size and decrease of thickness of a display device is less likely to be caused and distortion or twisting is less likely to be caused and also noise is less likely to be caused even if the device is used with being vibrated.

### BRIEF DESCRIPTION OF THE DRAWINGS

FIG. 1 is an exploded perspective view of a liquid crystal display device according to a first embodiment.

FIG. 2 is a plan view of a backlight unit.

FIG. 3 is a cross-sectional view of the liquid crystal display device including a reinforcing member.

FIG. 4 is an enlarged cross-sectional view of a part of the liquid crystal display device according to a second embodiment including a reinforcing member.

FIG. 5 is a plan view of a backlight unit according to another embodiment.

FIG. 6 is a perspective view of a liquid crystal display device according to another embodiment.

### DETAILED DESCRIPTION

### First Embodiment

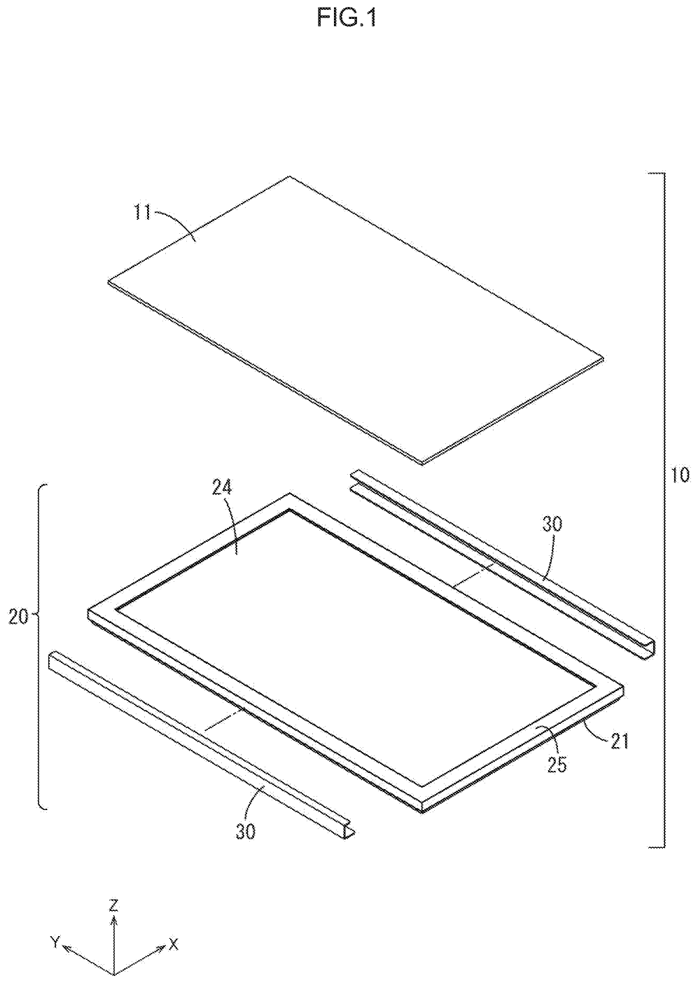

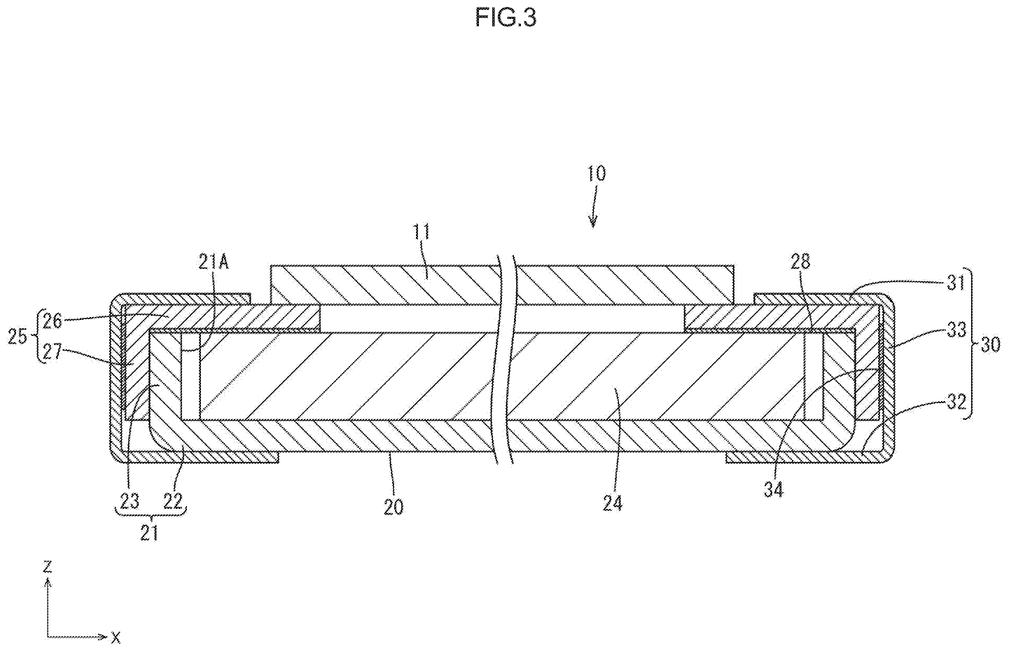

A liquid crystal display device 10 (an example of a display device) according to a first embodiment will be described with reference to FIGS. 1 to 3. X-axis, Y-axis and Z-axis may be indicated in each of the drawings. The axes in each drawing correspond to the respective axes in other drawings. A vertical direction is illustrated with reference to FIG. 3 and an upper side and a lower side correspond to a front side and a back side, respectively.

The liquid crystal display device 10 has a rectangular flat box shape as a whole and includes a liquid crystal panel (an example of a display panel) 11 and a backlight unit (an example of a lighting device) 20, as illustrated in FIG. 1. The liquid crystal panel 11 is configured to display images. The backlight unit 20 is arranged on a back side of the liquid crystal panel 11 and supplies light for display to the liquid crystal panel 11. The liquid crystal panel 11 and the backlight unit 20 are integrally held with a fixing tape.

The liquid crystal display device 10 may be mounted in a dashboard of a car as a part of an instrument panel to display a portion of meters of the instrument panel, various kinds of alarm images, map images of a car navigation system, or images taken by a built-in camera.

Details of the liquid crystal panel 11 are not illustrated. The liquid crystal panel 11 has a known configuration and includes a pair of rectangular substrates that are bonded to each other while having a predetermined gap therebetween and a liquid crystal layer between the substrates. Each of the substrates includes a glass substrate having high transmissivity such as non-alkaline glass and includes multiple films layered on each glass substrate with the known photolithography method.

One of the pair of the substrates on the back side (on a lower side in FIG. 3) is an array substrate and switching components (such as TFTs), pixel electrodes, and an alignment film are arranged on the array substrate. The switching components are connected to source lines and gate lines that are perpendicular to each other. The pixel electrodes are connected to the switching components. The other one of the substrates on the front side (on an upper side in FIG. 3) is a CF substrate. Color filters, a counter electrode, and an alignment film are arranged on the CF substrate. The color filters include color portions of red (R), green (G), and blue (B) that are arranged with predetermined alignment. The source lines, the gate lines, and the counter electrode are supplied with image data and various kinds of control signals, which are necessary for displaying images, from a control circuit board. Polarizing plates are bonded to outer surfaces of the substrates, respectively. The liquid crystal panel 11 displays images thereon with using light supplied by the backlight unit 20 and a front side thereof is a light exit side.

As illustrated in FIGS. 1 and 3, the backlight unit 20 (one example of a lighting device) includes a chassis 21 having a rectangular shallow plate shape, a frame 25 extending along an outer edge of the chassis 21, and a light exit member 24 that is arranged in the chassis 21. Light having plate shape as a whole exits the light exit member 24. The backlight unit 20 has substantially a block-like shape having a laterally elongated rectangular planar shape as a whole similar to the liquid crystal panel 11.

The chassis 21 is made of metal such as an aluminum plate or an electrogalvanized zinc-coated steel sheet (SECC). The chassis 21 includes a bottom plate 22 and a wall 23. The bottom plate 22 is a rectangular plate like the liquid crystal panel 11 and the wall 23 extends from a whole outer edge of the bottom plate 22 toward the front side (the light exit side). The chassis 21 has a rectangular shallow plate shape as a whole and has an open section 21A opening toward the liquid crystal panel 11 (the front side) as described before.

Although details of the light exit member 24 are not illustrated, the light exit member 24 arranged in the chassis 24 includes light emitting diodes 30 (LEDs), which are a light source, a LED board on which the LEDs are mounted, a light guide plate having a plate shape, an optical sheet, and a reflection sheet. Light emitted by the LEDs is guided within the light guide plate. The optical sheet is disposed on the front side of the light guide plate. The reflection sheet is disposed on the back side of the light guide plate.

The backlight unit 20 according to this embodiment is an edge light type (a side-light type) backlight unit of one-side light entering type in which light from the LEDs enters the light guide plate through one edge surface thereof. In the backlight unit 20, the light from the LEDs is converted by the light guide plate into planar light and the converted light exits through an open section 21A of the chassis 21 toward the liquid crystal panel 11 on the front side. The light exit member 24 is held in a predetermined position within the chassis 21 with a holding configuration.

The frame 25 is made of resin such as white polycarbonate having high reflectance and includes a frame section 26 and a wall cover section 27. The frame section 26 is opposite the bottom plate 22 and has a rectangular frame shape that covers an opening peripheral edge of the open section 21A of the chassis 21. The wall cover section 27 projects from an outer edge of the frame section 26 toward the back side so as to surround the wall 23 of the chassis 21 from an outer peripheral side. The frame 25 is fixed to the chassis 21 with a fixing tape 28 that is provided between the frame section 26 and an end surface of the wall 23 of the chassis 21. The quid crystal panel 11 is fixed to an upper surface (a front side surface) of the frame section 26 with a fixing tape.

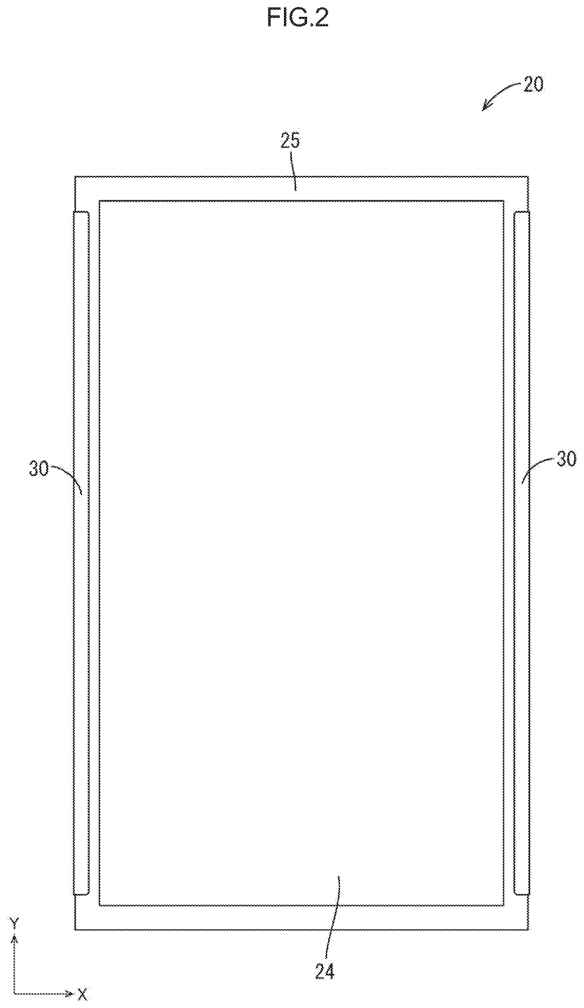

The backlight unit 20 of the present embodiment further includes a reinforcing member 30. The reinforcing member 30 is made of metal material having rigidity higher than that of the frame 25, such as stainless and preferably stainless steel for spring. In a plan view of the backlight unit 20 from the open section 21A as illustrated in FIG. 2, the reinforcing member 30 extends along each of long sides (the Y-axis direction) that are opposite each other and extends continuously to a portion near short sides. As illustrated in FIG. 3, the reinforcing member 30 has a channel structure having a substantially U-shaped cross sectional shape. Each of the reinforcing members 30 holds the edge sections of the backlight unit 20 with respect to the front-back direction (the vertical direction, the Z-axis direction).

More in detail, the reinforcing member 30 includes a frame-side extending section 31, a chassis-side extending section 32, and a connecting section 33. The frame-side extending section 31 overlaps the frame section 26 of the frame 25. The chassis-side extending section 32 is opposite the frame-side extending section 31, and the frame section 26 and the bottom plate 22 of the chassis 21 are sandwiched between the chassis-side extending section 32 and the frame-side extending section 31. The connecting section 33 is outside the wall cover section 27 of the frame 25 and connects edge portions of the frame-side extending section 31 and the chassis-side extending section 32. The frame-side extending section 31 has a width dimension in a width direction (the X-axis direction) thereof that is smaller than that of the frame section 26. According to such a configuration, the liquid crystal panel 11 is placed on an uncovered portion of the frame section 26. The chassis-side extending section 32 has a width dimension in a width direction (the X-axis direction) thereof that is greater than that of the frame-side extending section 31. The pair of reinforcing members 30 increases the rigidity of the whole backlight unit 20 and deformation such as warping or curving is less likely to be caused in the backlight unit 20 having increased size or decreased thickness. The reinforcing member 30 is fixed to the frame 25 with a belt-like fixing tape 34 that is provided between the connecting section 33 and the wall cover section 27 of the frame 25.

Next, operations and effects will be described. The backlight unit 20 of the present embodiment includes the light exit member 24, the chassis 21, the frame 25, and the reinforcing members 30. Light exits the light exit member 24. The chassis 21 includes the bottom plate 22, the wall 23 extending upward from the outer peripheral edge of the bottom plate 22, and the open section 21A that is opposite the bottom plate 22. The light exit member 24 is mounted inside the chassis 21. The frame 25 includes the frame section 26 and the wall cover section 27. The frame section 26 is opposite the bottom plate 22 and the opening edge of the open section 21A is covered with the frame section 26. The wall cover section 27 extends from the outer peripheral edge of the frame section 26 toward the bottom plate 22 so as to cover the outer periphery of the wall 23. The reinforcing member 30 is mounted on a portion of the outer peripheral portion of the frame 25. The reinforcing member 30 includes the frame-side extending section 31, the chassis-side extending section 32, and the connecting section 33. The frame-side extending section 31 extends along the outer periphery of the frame 25 and overlaps the frame section 26. The chassis-side extending section 32 is opposite the frame-side extending section 31, and the frame section 26 and the bottom plate 22 are sandwiched between the chassis-side extending section 32 and the frame-side extending section 31. The connecting section 33 is outside the wall cover section 27 and connects the frame-side extending section 31 and the chassis-side extending section 32.

According to the above configuration, even if the backlight unit 20 is increased in size or decreased in thickness, the backlight unit 20 including the reinforcing members 30 has enough rigidity for keeping its shape without causing deformation such as warping or curving. Furthermore, the frame 7 is formed to have relatively low rigidity so as to absorb distortion, a mounting tolerance of the chassis 21, or twisting as a whole that is caused by the mounting tolerance. Namely, the backlight unit 20 according to the present embodiment has both of rigidity for keeping the shape thereof and flexibility for sorbing distortion or twisting. Therefore, display unevenness of the liquid crystal display device 10 that is caused by distortion or twisting of the backlight unit 20 is less likely to occur. The backlight unit 20 including the reinforcing members 30 has rigidity with a reduced thickness. Therefore, the backlight unit 20 is less likely to be deformed by vibration of a vehicle and noise is less likely to be caused by the contact of the components.

The frame 25 has a rectangular plan view shape and the reinforcing members 30 are respectively mounted on a pair of long sides of the frame 25 that are opposite each other. The backlight unit 20 is likely to be warped and adversely affected by vibration in the long-side direction thereof, and according to the above configuration, the rigidity of the backlight unit 20 in the long-side direction thereof is increased. Therefore, much better effects can be obtained compared to a configuration including the reinforcing members on the short-side sections.

The reinforcing member 30 made of stainless steel for spring is less likely to be deformed compared to that made of other material, and much better effects are obtained.

### Second Embodiment

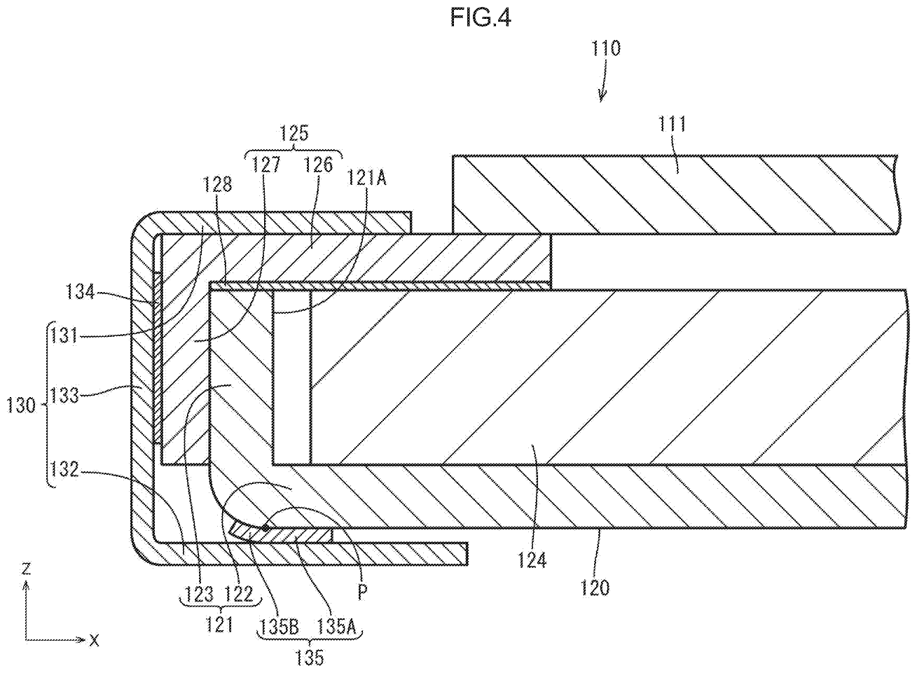

As illustrated in FIG. 4, a liquid crystal display device 110 according to the present embodiment differs from the liquid crystal display device 10 of the first embodiment in that a cushion tape 135 is disposed between the chassis 21 and the reinforcing member 30. Hereinafter, components same as those of the first embodiment are described with reference numbers adding 100 to those of the first embodiment and will not be described.

Hereinafter, reasons of providing such a cushion tape 135 will be described. The dimension tolerance and the mounting tolerance of each component are increased according to the increase of the size of a backlight unit 120. Therefore, a connecting section 133 of the reinforcing member 130 preferably has a greater dimension so as to absorb the increased tolerances. If the reinforcing member 130 has a dimension that cannot absorb the tolerances, the reinforcing member 130 may be forcefully mounted on a chassis 121 and a frame 125. In such a case, a light exit member 124 within the chassis 121 may be distorted.

On the other hand, in a liquid crystal display device used in a section that may receive vibration such as a car, if a space is crated between the reinforcing member 130 and each of the chassis 121 and the frame 125, looseness is created between the components by the vibration of a vehicle and the components may be hit each other, and noise is likely to be caused. Particularly, the chassis 121 and the reinforcing members 130 are made of metal material, as described before, and a cover glass and a touch panel are disposed on a liquid crystal panel 111 and this increases weight. Therefore, noise that may be caused between the chassis 121 and the reinforcing members 130 may be a serious problem. The reinforcing members 130 are preferably mounted on the chassis 121 tightly such that no space is created between at least the chassis 121 and the reinforcing members 130 to restrict noise.

The present embodiment is configured to include the cushion tape 135 (one example of cushioning material) between a bottom plate 122 of the chassis 121 and a chassis-side extending section 132 of the reinforcing member 130. The space between the bottom plate 122 and the chassis-side extending section 132 can be filled with the cushion tape 135 that can follow deformation. The cushion tape 135 is made of porous material that is good in shock absorbing properties. The cushion tape 135 has a belt-like shape extending along a long-side outer edge of the bottom plate 122 of the chassis 121 and is attached to the chassis 121 with a double-sided adhesive tape. The cushion tape 135 is not necessarily disposed over an entire area of a portion of the bottom plate 122 of the chassis 121 opposite the chassis-side extending section 132; however, the cushion tape 135 is preferably disposed on a portion near a border between the bottom plate 122 and a wall 123. The cushion tape 135 preferably extends to ends of the reinforcing member 130 in a length dimension thereof.

In detail, the cushion tape 135 includes a fiat portion 135A and a bent portion 135B. The cushion tape 135 is attached to the chassis 121 such that the flat portion 135A covers at least a flat surface area of the bottom plate 122 of the chassis 121 and the bent portion 135B covers at least a portion of a curved surface area of the chassis 121. The cushion tape 135 has a starting point P at which the cushion tape 135 starts to be bent from the flat area toward the wall 123. The cushion tape 135 includes the flat portion 135A and the bent portion 135B that extends from the flat portion 135A via the starting point P. As illustrated in FIG. 4, according to the present embodiment, the cushion tape 135 is attached to the bottom plate 122 such that one edge side portion (a left side portion in FIG. 4) with respect to the width direction (the X-axis direction) is slightly away from the chassis-side extending section 132 when the reinforcing member 130 is mounted on the chassis 121 and the frame 125. According to such a configuration, the cushion tape 135 is less likely to be removed from the chassis 121 when the reinforcing member 130 is mounted on the frame 125 and the chassis 121. Furthermore, even if the border section between the bottom plate 122 and a wall 123 has a shape projecting outwardly due to a bending stress, the projected portion is less likely to be contacted with the reinforcing member 130 directly by the vibration. The thickness of the cushion tape 135 that can restrict noise is about 0.1 mm or more.

The present embodiment has following operations and effects in addition to the operations and effects similar to the first embodiment. According to the light unit 120 according to this embodiment, the cushion tape 135 is disposed between the bottom plate 122 and the chassis-side extending section 132. Therefore, even if the chassis 121 and the reinforcing member 130 are made of metal, looseness is less likely to be created between the components due to the vibration of a vehicle, and the metal chassis 121 and the reinforcing member 130 are less likely to be hit each other, and noise is less likely to be caused.

The cushion tape 135 extends from the bottom plate 122 toward the wall 123 while having the starting point P at which the cushion tape 135 starts to be bent therebetween. With such a configuration, even if the border section between the bottom plate 122 and the wall 123 of the chassis 121 has a shape projecting outwardly, the projected portion is less likely to be contacted with the reinforcing member 130 directly by the vibration and noise is less likely to be caused. Further, the cushion tape 135 is less likely to be removed from the chassis 121 when the reinforcing member 130 is mounted on the chassis 121.

### Other Embodiments

The present technology is not limited to the embodiments described in the above and the drawings but the embodiments described below may be included in the technical scope.

(1) In the above embodiments, the backlight devices 20, 120 include the respective reinforcing members 30, 130 on a pair of long sides thereof; however, the reinforcing members may be included on a pair of short sides, three sides, or all of the sides of the backlight device.

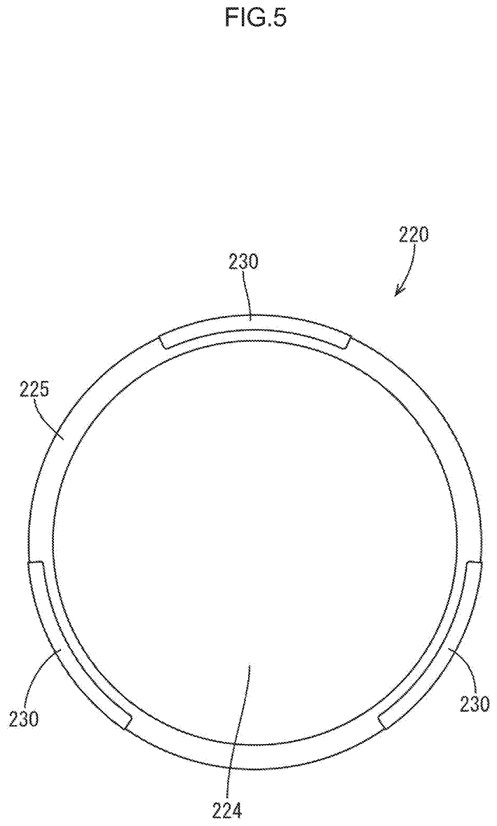

(2) In the above embodiments, the liquid crystal display devices 10, 110 and the backlight units 20, 120 have a rectangular plan view shape; however, the display device and the lighting device may not necessarily have the shape of the above embodiment but may have various other shapes. For example, a display device and a backlight unit 220 may have a circular plan view shape and a disk-like overall shape (see FIG. 5). In such a configuration, the backlight unit 220 may include a reinforcing member 230 that is divided into three reinforcing members 230 in three directions in a plan view of the backlight unit 220, and each reinforcing member 230 extends along an outer periphery of a frame 225. The reinforcing members 230 may be provided in any numbers and any directions. The reinforcing members 230 are preferably disposed so as to restrict distortion and twisting of the backlight unit 220 caused by distortion of the reinforcing member 230 itself. The liquid crystal display device and the backlight unit may have various shapes such as a fan shape, a polygonal shape, and an oval shape.

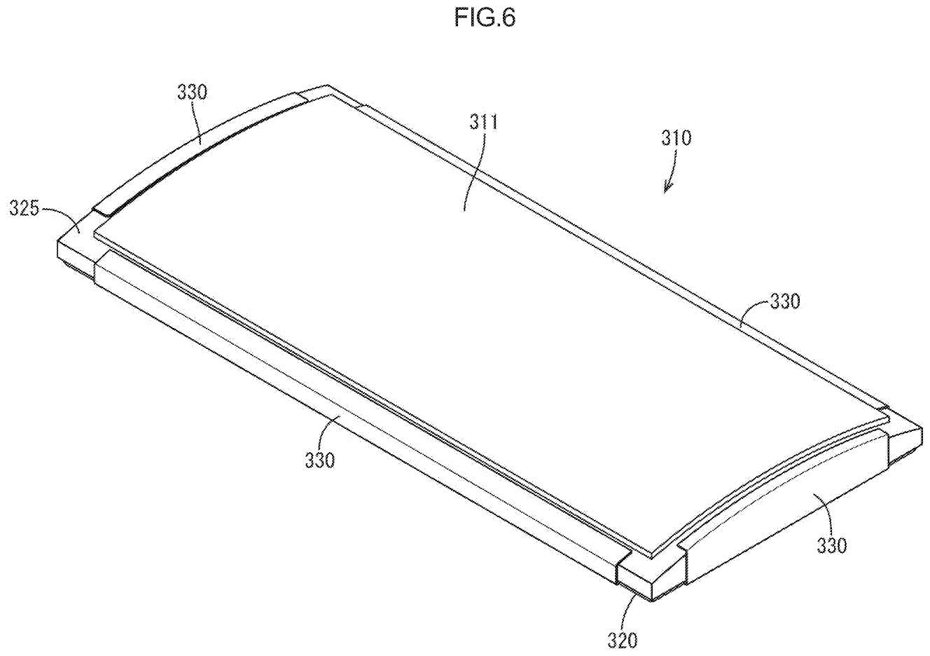

(3) As illustrated in FIG. 6, the present technology may be applied to a curved liquid crystal display device 310 and a curved backlight unit 320 including a curved surface. In such a configuration, a reinforcing member 330 may be formed to be along a frame 325 so as to be mounted on the frame 325. The reinforcing member 330 may be mounted on any edge of the backlight unit 320.

(4) In the above embodiments, the chassis 21, 121 and the reinforcing members 30, 130 are made of metal; however, one of them or both of them may be made of resin.

(5) In the second embodiment, the cushioning material disposed between the bottom plate 122 of the chassis 121 and the chassis-side extending section 132 of the reinforcing member 130 is the cushion tape 135 made of porous material; however, the cushioning material is not necessarily the one described in the above embodiment but may be elastic material such as rubber. The cushioning material may be any material as long as it is deformable to fill a space and restrict hitting caused by the vibration.

(6) In the second embodiment, the cushion tape 135 that is disposed between one reinforcing member 130 and the chassis 121 has a continuous belt like shape; however, the cushion tape 135 does not necessarily have the shape of the above embodiment. For example, the cushion tape may be divided into belt-like pieces and multiple cushion tapes may provided for one reinforcing member 130.

(7) In the second embodiment, the cushion tape 135 is attached to the chassis 121; however, the cushion tape 135 may be attached to the reinforcing member 130. In such a configuration, the cushion tape 135 may preferably extend to a portion of the wall 123 over the starting point P at which the cushion tape 135 starts to be bent from the bottom plate 122.

(8) The cushion tape may not necessarily extend over the starting point P but may be provided only between the bottom plate 122 and the chassis-side extending section 132.

(9) The above embodiments include the edge light type backlight units 20, 120; however, the backlight unit may be a top surface light emission type backlight unit.

(10) The configurations, the mounting mechanism, and the fixing structure of the chassis 21, 121 and the frame 25, 125 are not necessarily limited to those of the above embodiments but may be altered. For example, the chassis may be configured not to include the wall over an entire periphery thereof, or may include studs, holes or bent portions, or multiple chassis may be included. Further, for example, the components may not be fixed with a fixing tape but may be fixed with outsert molding or adhesive.

(11) In the above embodiments, the liquid crystal panel 11, 111 that includes the liquid crystal layer between a pair of substrates is used as the display panel; however, a display panel that includes functional organic molecules other than the liquid crystal material between the pair of substrates may be used.

(12) The components included in the display device and the lighting device may not be limited to those of the above embodiments. Configurations including other components such as a bezel, a cover glass, or a touch panel may be included in the technical scope.

1. A lighting device comprising:
a light exit member configured to exit light;
a chassis including a bottom plate, a wall that extends from an outer peripheral portion of the bottom plate, and an open section opposite the bottom plate, the chassis in which the light exit member is arranged;
a frame including a frame section and a wall cover section, the frame section being disposed opposite the bottom plate and covering an open edge of the open section, and the wall cover section extending from an outer peripheral edge of the frame section toward the bottom plate and covering an outer periphery of the wall; and
a reinforcing member disposed on at least a portion of an outer periphery of the frame, the reinforcing member including
a frame-side extending section extending along the outer periphery of the frame and overlapping the frame section,
a chassis-side extending section disposed opposite the frame-side extending section, and the frame-side extending section and the chassis-side extending section holding the frame section and the bottom plate therebetween, and
a connecting section disposed on an outer side of the wall cover section and connecting the frame-side extending section and the chassis-side extending section.

2. The lighting device according to claim 1, wherein the frame has a rectangular plan view shape and the reinforcing member is disposed on a pair of long sides of the frame.

3. The lighting device according to claim 1, further comprising cushioning material disposed between the bottom plate and the chassis-side extending section, wherein
the chassis and the reinforcing member are made of metal.

4. The lighting device according to claim 3, wherein the cushioning material extends from the bottom plate over a portion where the cushioning material starts to be bent toward the wall.

5. A display device comprising:
the lighting device according to claim 1; and
a display panel.
